(19) United States
(12) Patent Application Publication
(10) Pub. No.: US 2006/0007893 A1
(43) Pub. Date: Jan. 12, 2006

(54) System for adapting printed literary, educational, and business works to fixed-line and mobile telephony networks

(76) Inventor: Mark Kaplan, New York, NY (US)

Correspondence Address: KATTEN MUCHIN ROSENMAN LLP, 575 MADISON AVENUE, NEW YORK, NY, 10022-2585, US

(21) Appl. No.: 10/924,272

(22) Filed: Aug. 23, 2004

Related U.S. Application Data
(60) Provisional application No. 60/521,844, filed on Jul. 9, 2004.

(51) Int. Cl. H04B 7/216

(52) U.S. Cl. 370/335

(57) ABSTRACT

A fixed line or wireless telephone user is provided with means for accessing a published literary work that has been dictated and transcribed on a server. The content may be accessed by one or more users simultaneously and may be provided to the user as either audio or text. The audio content may be accompanied by a corresponding visual data feed that may include text, illustrations, motion pictures, animations and photographs. Access to the literary content may be provided as a subscriber service in which the user may receive periodic subscription renewal notifications. The renewal messages may be delivered as SMS, EMS, or MMS messages.

### RELATED APPLICATIONS

The present application claims the benefit of provisional patent application “A System for Adapting Printed Literary, Educational and Business Works to Fixed Line and Mobile Telephony Networks,” Ser. No. 60/521,844, filed Jul. 9, 2004.

### BACKGROUND OF THE INVENTION

1. Field of Invention

The present invention relates to the adaptation of printed literary, educational, and business works for transmission, retrieval, reception, and distribution over a network and more specifically, to a system and protocol for communicating interactively the adapted content utilizing mobile and fixed line telecommunications networks.

2. Discussion of Prior Art

The Internet is a communication medium used for the transmission of data between networks, wherein such data can be accessed by an end-user using a computer (and rendered via a display system connected to the computer) or television set equipped with appropriate retrieval technology. Internet data usually comprises specific electronic entertainment data, commerce data, or specific user-requested data. Services provided on the Internet include, but are not limited to, news, sports information, audio broadcasting, video broadcasting, and auctions.

Telephony is used to transmit voice and data services that are accessible by an end-user via a reception/transmission system such as a phone (e.g., a mobile phone) or other compatible hardware (e.g., mobile hardware such as Blackberry©). Telephony provides, upon request, voice and data communications along with entertainment information and interactive services. Applications on mobile phones include voice services, voicemail, voting, music downloading, and text messaging. Mobile calendars, address books, notebooks, and organizers can only be programmed directly onto the handset or by connecting the mobile handset to a computer with a cable or connectivity port.

Both the Internet and telephony feed consumers data upon request. For example, in the Internet scenario, a user subscribes with an Internet Service Provider (“ISP”) and is provided Internet access. Likewise, in the telephony scenario, a user subscribes with a telecommunications company (“TELCO”) and is authorized for appropriate phone usage. In such subscription-based services, a user pays a fee for a connection and/or usage rates, and the ISP or the carrier renders services based on such fees. The user may use the Internet and/or their phones for many applications, such as accessing the Internet from his/her phone. The usage and choices made in both scenarios are operated and recorded on servers in the respective provider facilities.

Currently, printed literary, educational, and business works are offered in hard copy form where the works are published either onto paper or digitized and stored in computer readable medium and provided to the consumer. Audio-adapted works are provided on compact disc (CD) or cassette, whereas digitized data versions are provided on CD-ROM or over the Internet.

The following references generally illustrate mobile devices that can be provided with digital content over a network.

The patent to Posa et al. (U.S. Pat. No. 6,633,741 B1) provides for a recap, summary, and auxiliary information generation for electronic books. An electronic book player unit is provided with a user interface, a display device, and an audio presentation system for interacting with a user. The player unit may download the audio, text, and other presentation elements of an electronic book via network interfaces.

The patent application to Wu (2003/0200095 A1) provides for a method for presenting text information with speech utilizing information processing apparatus. An electronic book can be downloaded over a network, such as the Internet, to a PDA having a network interface as well as an input unit, a memory, a speaker, and a display unit. The received text is converted into speech using a speech microchip and a speech database stored locally on the device. In this manner, download text is translated into audio which is output using the speaker.

The patent application to Calvert (2004/0078812 A1) provides for a method and apparatus for acquiring media services available from content aggregators. A playback device communicates with a content aggregator by means of a communications network. The content aggregator provides a variety of media content and services to the playback device using audio and video feeds.

The patent application to Cross (2004/0090991 A1) provides for an intelligent network-based system and method for customized program broadcasting and reception. The broadcasting and reception system uses existing hardware of an intelligent network, including a service control point (SCP), which comprises an intelligent service node (ISN) and a subscriber database, as well as various wired and wireless networks, including a public switched telephone network (PSTN), the Internet, and a wireless network.

The patent application to Liu et al. (2003/0093545 A1) provides for a method and system for downloading data to portable electronic device, wherein a user may access electronic book data using a cellular telephone.

The patent application to Blom et al. (2003/0131353 A1) provides for a method of rights management for streaming media, including electronic books. Blom's system may use SMS to transfer content and digital rights.

Whatever the precise merits, features, and advantages of the above cited references, none of them achieves or fulfills the purposes of the present invention.

### SUMMARY OF THE INVENTION

The present invention provides for a system and method to utilize existing mobile and fixed-line telecommunications infrastructures allowing users to access audio dictations and unique visual representations of printed works. The present invention also utilizes existing telecommunications infrastructures to allow users to be provided with a scheduled renewal or subscription of their telephony-adapted printed works. The present invention uses messaging services along with the functionality of services such as (but not limited to) an Interactive Voice Response (IVR) server, General Packet Radio Service (GPRS), or voice mail service to authenticate access and deliver content. Messaging services operable in conjunction with the present invention include, but are not limited to, the Short Code Messaging Service (SMS), Enhanced Messaging Service (EMS), Multimedia Messaging Service (MMS), messaging based on Compact Media Extensions (CMX), messaging based on the Java™ 2 Platform, messaging based on the Micro Edition (JAVAE™), and messaging based on the Wireless Application Protocol (WAP).

In the current invention, the published work is dictated onto an Interactive Voice Response (IVR) server where it is processed and stored in an appropriate format for delivery via the respective telecommunications platform. Once the data is stored on the telecommunications service provider's back-end servers, it may be accessed on demand by a single user or multiple users simultaneously by accessing the content via their mobile carrier or a fixed-line phone service. The audio file may also be streamed to the consumer from the telecommunications provider's back-end servers via GPRS.

In another embodiment of the current invention, the adaptation of the original printed work is transcribed into single or multiple short form text assets to create the complete and direct adaptation of the original work.

In yet another embodiment of the current invention, the adaptation of the published work is dictated into an audio format and combined with data to create a multimedia asset. The data portion of the asset may include one or a combination of visual text, animation, motion picture, numeric, or other visual representation. Once the asset is created, it is stored on the telecommunications service provider's back-end servers, thus enabling on-demand consumer access via, for example, their mobile carrier. Similarly, a WAP asset is delivered from the telecommunications provider's back-end servers with separate, but corresponding, GPRS feed serving the audio portion of the content.

In another embodiment of the current invention the audio transmission sent from the IVR is simultaneously accompanied by a separate, but corresponding, data asset sent from the data server in the telecommunications provider's back-end.

In yet another embodiment of the invention, the consumer is given the option regarding receiving automated notifications of new content offerings along with pre-authenticated access to the refreshed content. The opt-in options are stored in the telecommunications back-end servers, where the system is instructed to automatically send a notification transmission to the consumer. This notification will be unique for fixed line and mobile users. For example, fixed line users will receive an automated voice mail or phone call to serve as notification. As a similar example, mobile users will receive a text or multimedia message (via, SMS, EMS, MMS, etc.) that will serve as their notification. The opt-in option is stored on the back-end servers and recognized in the authentication steps of the previous embodiments, so it does not affect the value chain.

### BRIEF DESCRIPTION OF THE DRAWINGS

FIGS. 1a-b illustrate an embodiment of the present invention showing the adaptation of a printed work using an interactive voice response server.

FIG. 2 illustrates an embodiment of the present invention showing a text only adaptation of a printed work.

FIG. 3 illustrates an embodiment of the present invention showing a multimedia adaptation of a printed work.

FIG. 4 illustrates an embodiment of the present invention showing an IVR and multimedia adaptation of a printed work.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The definitions provided below help assist in the understanding of terminology used throughout the specification. It should, however, be noted that definitions have been provided to help with general understanding of personal information management systems and are not meant to limit their interpretation thereof. Furthermore, other definitions and equivalents may be substituted therefore without departing from the scope of the present invention.

Wireless Application Protocol (WAP): WAP is a protocol that has successfully established a de facto standard for the way in which wireless technology is used for Internet access. WAP technology has been optimized for information delivery to thin-client devices, such as mobile phones. In contrast to traditional Web applications allowing the user to communicate with remote, location-unaware servers, WAP over Bluetooth enables the user to connect through, and interact with devices in their proximity.

General Packet Radio Service (GPRS): With GPRS, a continuous wireless connection to data networks is established and access to favorite information and entertainment services is provided. GPRS technology allows mobile phones to be used for sending and receiving data over an Internet Protocol (IP)-based network. GPRS as such is a data bearer that enables wireless access to data networks like the Internet.

Interactive Voice Response (IVR): An IVR System can be used to automate a wide range of services and data requests. By combining the input of the caller with menu driven scripts, clients, potential clients, and employees can call into an organization or to a remote IVR call center, using a touch-tone telephone and interact with the system, in real time, with a host of applications. In addition to touch tone input, many advanced IVR systems can utilize speaker independent voice recognition to allow the caller to simply “speak” their requests which generate the desired responses or system look-ups.

Shortcode Message Service (SMS): SMS provides a mechanism for transmitting short messages to and from wireless devices. The service makes use of an SMSC, which acts as a store-and-forward system for short messages. The wireless network provides the mechanisms required to find the destination station(s) and transports short messages between the SMSCs and wireless stations. In contrast to other existing text-message transmission services such as alphanumeric paging, the service elements are designed to provide guaranteed delivery of text messages to the destination. Additionally, SMS supports several input mechanisms that allow interconnection with different message sources and destinations. SMS is characterized by out-of-band packet delivery and low-bandwidth message transfer, which results in a highly efficient means for transmitting short bursts of data.

Enhanced Messaging System (EMS): EMS extends text messaging to include pictures, melodies, animations and long, formatted text messages. EMS is frequently used to send ringtones and wallpapers to phones over the web. EMS is the ability to send ringtones, logos and other simple visual messages to EMS capable handsets and additionally the ability to send and receive a combination of simple media such as melodies, pictures, sounds, animations, modified text and standard text as an integrated message for display on an EMS compliant handset. Extending the use of the long established and widely used User Data Header (UDH) common in SMS has standardized the EMS. The UDH makes it possible to include binary data in a normal short message prior the text message itself, like an envelope to a letter.

Multimedia Message Service (MMS): MMS encompasses a wide range of content types and is a logical extension of SMS, making it easily adoptable for today's generation of mobile users. Another advantage of MMS is that the message is a multimedia presentation in a single entry, not a text file with attachments, making it much simpler and user-friendly. MMS standard lists JPEG, GIF, text, AMR voice, and other formats as supported media types, while unsupported formats are handled in a controlled way. Like SMS, MMS is an open industry standard, and MMS messages can be delivered using existing networks and protocols. MMS is also bearer-independent, which means it is not limited to GSM or WCDMA networks.

Compact Media Extensions (CMX): Compact Media Extensions™ (CMX™) multimedia software is a cost-effective approach that enables developers to develop customized ringtones and screensavers. Content developers can create rich content that provides for time-synchronization of MIDI-based voice, text, music, graphics and animation, delivering exciting and compelling content to the marketplace. CMX functions much like MMS for QUALCOMM® phone handsets and devices.

Java 2 Platform, Micro Edition (JAVA): Developed within the Java Community Process as JSR 172, the J2ME Web Services API (WSA) extends the Java 2 Platform, Micro Edition to support web services. The API's two optional packages standardize two areas of functionality that are crucial to clients of web services: remote service invocation and XML parsing.

Fundamental support for web services invocation and XML parsing is integrated into the device's runtime environment, so developers don't have to embed such functionality in each application—an especially expensive proposition in resource-constrained devices like mobile phones and personal digital assistants.

Binary Runtime Environment for Wireless (BREW): BREW makes it possible for developers to create portable applications that will work on any handsets equipped with CDMA chipsets. Because BREW runs in between the application and the chip operating system software, the application can use the device's functionality without the developer needing to code to the system interface or even having to understand wireless applications. Users can download applications—such as text chat, enhanced e-mail, location positioning, games (both online and offline), and Internet radio—from carrier networks to any BREW-enabled phone.

BREW is competing for wireless software market share with J2ME (Java 2 Micro Edition), a similar platform from Sun Microsystems. The initial version of BREW is solely intended for CDMA networks; but, later versions could be enabled for time division multiple access (TDMA) and Global System for Mobile Communication (GSM) networks.

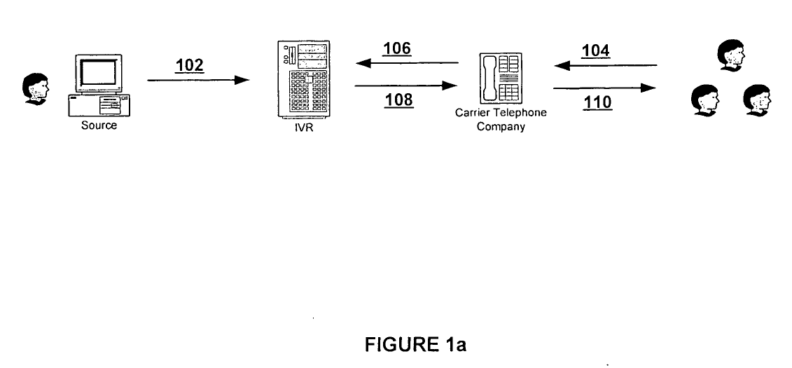

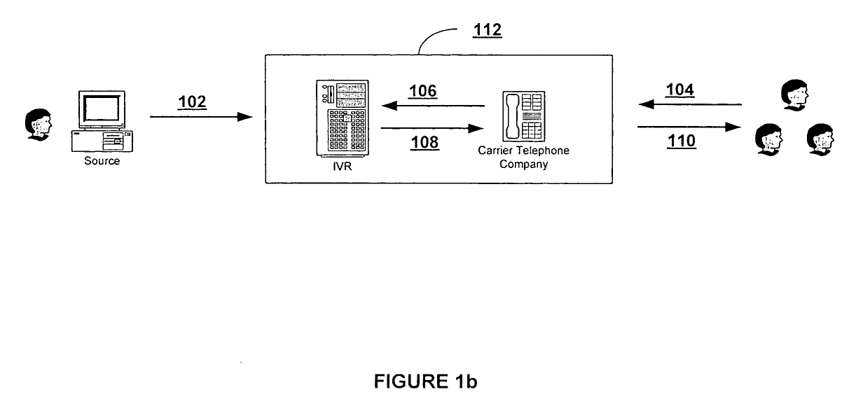

FIG. 1a illustrates an embodiment of the present invention showing the adaptation of a printed work using an Interactive Voice Response (IVR) server. In step 102, the source content (original work) is dictated, converted into a digital file, and transported via a network such as the Internet to the telecommunications service provider. It should be noted that source content can also be delivered via other means (e.g., digital data stored on a medium such as CD-ROM) to the telecommunications service provider. The telecommunications service provider stores the received data in an appropriate format (e.g., an audio format) on the IVR server. Once the file is on the IVR, the consumer is able to access the content on-demand.

In step 104, users utilize a telecommunications network, such as a mobile telephone network, or a fixed line telephone service network to access the IVR by sending a data message using a mobile device or by calling an access number from either a mobile device or fixed access device. Next, in step 106, once the user initiates the communication, the user's mobile carrier or fixed line provider passes the connection through to the IVR. Once the request connection is received and processed by the IVR, then, in step 108, the IVR transports the content. In step 110, the content is transported to the consumer via their mobile carrier network or fixed line phone service network. It should be noted that in some cases the IVR server may be housed in the mobile carrier or fixed line phone service provider's facility. For example, FIG. 1b illustrates a scenario wherein both the IVR server is housed in the mobile carrier or fixed line telephone service provider's facility 112. In other instances, there is a third party IVR service provider.

In the current invention, the published work is dictated onto an Interactive Voice Response (IVR) server where it is processed and stored in an appropriate format for delivery via the respective telecommunications platform. Once the data is stored on the telecommunications service provider's back-end servers, it may be accessed on demand by a single user or multiple users simultaneously by accessing the content via their mobile carrier or a fixed line phone service. The audio file may also be streamed to the consumer from the telecommunications provider's back-end servers via GPRS.

In another embodiment of the current invention, the adaptation of the original printed work is transcribed into single or multiple short form text assets to create the complete and direct adaptation of the original work.

In yet another embodiment of the current invention, the adaptation of the published work is dictated into an audio format and combined with data to create a multimedia asset. The data portion of the asset may include one or a combination of visual text, animation, motion picture, numeric, or other visual representation. Once the asset is created, it is stored on the telecommunications service provider's back-end servers, thus enabling on-demand consumer access via, for example, their mobile carrier. Similarly, a WAP asset is delivered from the telecommunications provider's back-end servers with a separate, but corresponding, GPRS feed serving the audio portion of the content.

In another embodiment of the current invention, the audio transmission sent from the IVR is simultaneously accompanied by a separate, but corresponding, data asset sent from the data server in the telecommunications provider's back-end.

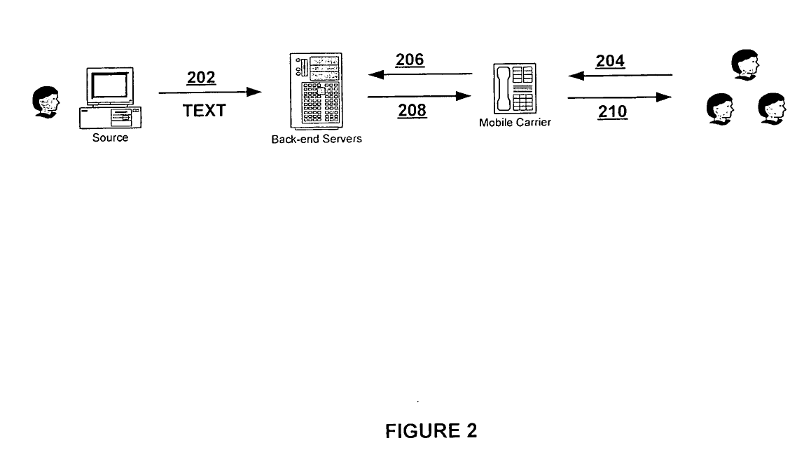

FIG. 2 illustrates an embodiment of the present invention showing a text-only adaptation of a printed work. In step 202, the original printed work is transcribed into cataloged digital text files at the content source. The digital text is then transported via a network, such as the Internet, or other means of delivering digital data (e.g., via CD-ROM) to the telecommunications service provider with cataloging instructions. Then, digital text files are formatted appropriately by the telecommunications service provider according to the different technical requirements for different mobile carriers. Once formatted, the digital files are cataloged and stored for distribution to the consumer, upon their request, via their mobile carrier. In step 204, the consumer initiates access to the content by initiating a request via their mobile carrier, and in step 206, the back-end servers authenticate the consumer's request. Once authentication is complete, in step 208, the digital text files are transported from the back-end servers to the consumer via the mobile carrier. The mobile carrier, in step 210, makes content available to the consumer.

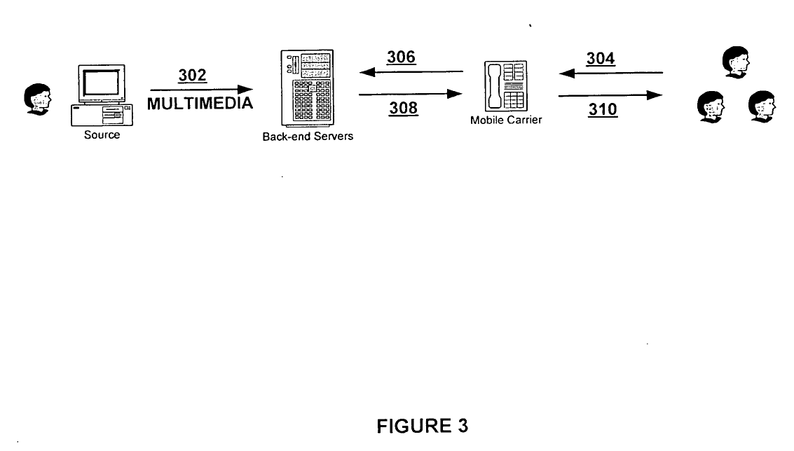

FIG. 3 illustrates another embodiment of the present invention depicting a multimedia adaptation of a printed work. In step 302, the original, printed work is transcribed into cataloged digital multimedia files at the content source. It should be noted that the printed work can be produced in a format suitable for delivery via a messaging service, wherein such a format is based on any of, but not limited to, the following technologies: SMS, EMS, MMS, CMX, WAP, JAVA, BREW, or GPRS. Due to compatibility variations in consumer devices and TELCO delivery methods and in order to achieve ubiquitous adoption of the adapted work, it may be produced in multiple formats. Then, multimedia files are transported via a network, such as the Internet, or other means of delivering digital data (e.g., via CD-ROM) to the telecommunications service provider with cataloging instructions. Then, digital text files are formatted appropriately by the telecommunications service provider according to the different technical requirements for different mobile carriers. Once formatted, the files are cataloged and stored for distribution to the consumer, upon their request, via their mobile carrier. The consumer, in step 304, initiates access to the content by initiating a request via their mobile carrier, and in step 306, the back-end servers authenticate the consumer request. Once authentication is complete, in step 308, the digital text files are transported from the back-end servers to the consumer via the mobile carrier. In step 310, the mobile carrier makes content available to the consumer

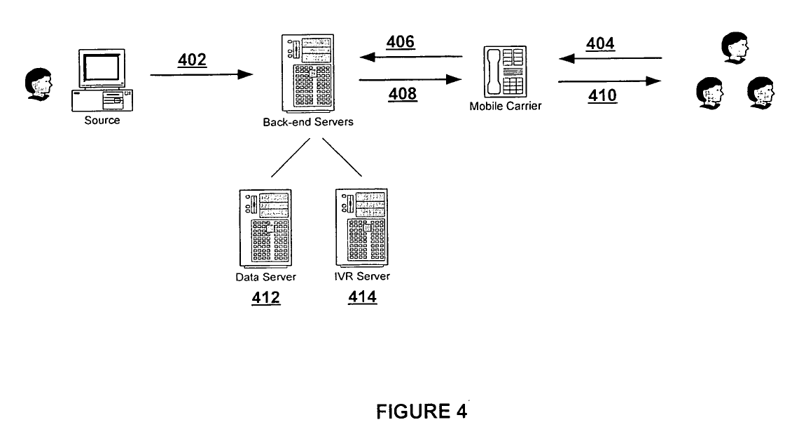

FIG. 4 illustrates yet another embodiment of the present invention depicting an IVR and multimedia adaptation of a printed work. In step 402, the original printed work is transcribed into cataloged digital multimedia files; as well as dictated and converted into a digital audio file at the content source. It should be noted that the printed work can be produced in a fonmat suitable for delivery via a messaging service, wherein such a format is based on any of, but not limited to, the following technologies: SMS, EMS, MMS, CMX, WAP, JAVA, BREW, or GPRS. Due to compatibility variations in consumer devices and TELCO delivery method; in order to achieve ubiquitous adoption of the adopted work it may be produced in multiple formats. Then, the multimedia file and the audio file are transported via a network, such as the Internet, or other means of delivering digital data (e.g., via CD-ROM) to the telecommunications service provider with cataloging instructions. Then, the telecommunications service provider formats the files and stores them on respective servers appropriately according to different technical requirements for different mobile carriers. Once formatted, the files are cataloged and stored for distribution to the consumer, upon their request, via their mobile carrier. In one embodiment, the audio files are stored on an IVR server 414, and the multimedia or text files are stored on a data server 412. In step 402, the consumer initiates access to the content by initiating a request via their mobile carrier, and in step 406, the back-end servers authenticate the consumer request. Once authentication is complete, in step 408, the audio and data files are simultaneously transported from the back-end servers to the consumer via the mobile carrier. In step 410, the mobile carrier makes content available to the consumer.

In another embodiment of the invention, the consumer is given the option regarding receiving automated notifications of new content offerings along with pre-authenticated access to the refreshed content. The opt-in options are stored in the telecommunications back-end servers, where the system is instructed to automatically send a notification transmission to the consumer. This notification will be unique for fixed line and mobile users. For example, fixed line users will receive an automated voice mail or phone call to serve as notification. As a similar example, mobile users will receive a text or multimedia message (via, SMS, EMS, MMS, etc.) that will serve as their notification. The opt-in option is stored on the back-end servers and recognized in the authentication steps of the previous embodiments, so it does not affect the value chain.

Additionally, the present invention provides for an article of manufacture comprising computer readable program code contained within implementing one or more modules for adapting printed works to fixed line and mobile telecommunication platforms. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules working in conjunction with a computer to: receive data via a network, wherein the received data comprises a digitized format of dictated audio inputs corresponding to a printed work; store the received data in a format appropriate for on-demand retrieval via at least one telecommunication device; receive a request for on-demand retrieval of the stored data from a telecommunication device; transmit requested on-demand printed content in a format suitable of being rendered in the requesting telecommunications device.

### CONCLUSION

A system and method has been shown in the above embodiments for the effective implementation of a system and method to adapt printed literary, educational, and business works to fixed-line and mobile telephony networks. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network programming.

1. A method to adapt a printed work for retrieval over existing telecommunication infrastructures, said method comprising the steps of:
receiving data via a network, said received data comprising a digitized format of dictated audio inputs corresponding to a printed work;
storing said received data in a format appropriate for on-demand retrieval via at least one telecommunication device;
receiving a request for on-demand retrieval of said stored data from a telecommunication device; and
transmitting requested on-demand printed content in a format suitable of being rendered in said requesting telecommunications device.

2. The method as per claim 1, wherein said requesting telecommunications device is a mobile telephone, Personal Digital Assistant (PDA), or a fixed-line telephone.

3. The method as per claim 1, wherein said received data is any of, or a combination of, the following: text or multimedia.

4. The method as per claim 1, wherein a message received via a messaging service triggers the reception of data comprising the digitized format of dictated inputs.

5. The method as per claim 4, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

6. The method as per claim 1, wherein authentication of a subscriber is performed prior to said reception step, said authentication performed via a messaging service.

7. The method as per claim 6, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

8. The method as per claim 1, wherein said received data is preprocessed at an interactive voice response server that receives said dictated audio inputs and converts said received inputs into said digitized format.

9. The method as per claim 1, wherein said received data further comprises multimedia assets associated with said digitized audio inputs.

10. The method as per claim 9, wherein said multimedia assets comprise any of, or a combination of, the following: visual text, animation, video, motion picture, a numeric representation, or a visual representation.

11. The method as per claim 1, wherein said on-demand retrieval request is initiated based upon an automated notification sent to a telecommunication device, said automated notification triggered by an update to said stored data.

12. The method as per claim 11, wherein said notification is any of the following: a voice mail, a telephone call, or a message via a messaging service.

13. The method as per claim 12, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

14. The method as per claim 1, wherein said network is any of the following: local area network (LAN), wide area network (WAN), wireless network, telecommunication network, or the Internet.

15. A computer usable medium having computer readable program code means embodied therein for working in conjunction with a computer to adapt a printed work for retrieval over existing telecommunication infrastructures, said medium comprising:
computer readable program code working in conjunction with said computer to receive data via a network, said received data comprising a digitized format of dictated audio inputs corresponding to a printed work;
computer readable program code working in conjunction with said computer to store said received data in a format appropriate for on-demand retrieval via at least one telecommunication device;
computer readable program code working in conjunction with said computer to receive a request for on-demand retrieval of said stored data from a telecommunication device; and
computer readable program code working in conjunction with said computer to transmit requested on-demand printed content in a format suitable of being rendered in said requesting telecommunications device.

16. A method to adapt a printed work for on-demand retrieval and modification by one or more subscribers associated with said printed work, said adaptation performed over existing telecommunication infrastructures, said printed work digitized and stored in a server capable of communicating with said subscribers, said method comprising the steps of:
monitoring and identifying modifications to digitized stored data corresponding to a printed work, said modifications performed by a subscriber associated with said printed work;
upon successful modification to said digitized stored data by a subscriber, generating an automatic notification for transmission via a messaging service for remainder of said subscribers;
transmitting said automatic notification to said remainder of subscribers via said messaging service;
receiving a request for on-demand retrieval of said stored data from a telecommunication device associated with at least one of said remainder of subscribers; and
transmitting requested on-demand printed content in a format suitable of being rendered in said requesting telecommunications device.

17. The method as per claim 16, wherein said requesting telecommunications device is a mobile telephone, Personal Digital Assistant (PDA), or a fixed line telephone.

18. The method as per claim 16, wherein said stored digitized data is any of, or a combination of, the following: text or multimedia.

19. The method as per claim 16, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

20. The method as per claim 16, wherein authentication of a subscriber is performed prior to said reception step, said authentication performed via a messaging service.

21. The method as per claim 20, wherein said messaging service is any of the following: short code messaging service (SMS), enhanced messaging service (EMS), multimedia messaging service (MMS), messaging based on Compact Media Extensions (CMX), messaging based on the Java Platform, or messaging based on the Wireless Application Protocol (WAP).

22. The method as per claim 16, wherein said stored data further comprises multimedia assets associated with said printed work.

23. The method as per claim 22, wherein said multimedia assets comprise any of, or a combination of, the following: visual text, animation, video, motion picture, a numeric representation, or a visual representation.

24. The method as per claim 16, wherein said network is any of the following: local area network (LAN), wide area network (WAN), wireless network, telecommunication network, or the Internet.

25. A computer usable medium having computer readable program code means embodied therein for working in conjunction with a computer to adapt a printed work for on-demand retrieval and modification by one or more subscribers associated with said printed work, said adaptation performed over existing telecommunication infrastructures, said printed work digitized and stored in a server capable of communicating with said subscribers, said medium comprising:
computer readable program code working in conjunction with said computer to monitor and identify modifications to digitized stored data corresponding to a printed work, said modifications performed by a subscriber associated with said printed work;
upon successful modification to said digitized stored data by a subscriber, computer readable program code working in conjunction with said computer to generate an automatic notification for transmission via a messaging service for remainder of said subscribers;
computer readable program code working in conjunction with said computer to transmit said automatic notification to said remainder of subscribers via said messaging service;
computer readable program code working in conjunction with said computer to receive a request for on-demand retrieval of said stored data from a telecommunication device associated with at least one of said remainder of subscribers; and
computer readable program code working in conjunction with said computer to transmit requested on-demand printed content in a format suitable of being rendered in said requesting telecommunications device.

26. A system to adapt a printed work for retrieval over existing telecommunication infrastructures, said system comprising:
a first server to receive and store data via a network, said stored data comprising a digitized format of dictated audio inputs corresponding to a printed work and said data stored in a format appropriate for on-demand retrieval via at least one telecommunication device; and
a second server working in conjunction with said first server, said second server receives a request for on-demand retrieval of said stored data from a telecommunication device and transmits requested on-demand printed content in a format suitable of being rendered in said requesting telecommunications device.

27. The system as per claim 26, wherein said requesting telecommunications device is a mobile telephone, Personal Digital Assistant (PDA), or a fixed line telephone.

28. The system as per claim 26, wherein said received data is any of, or a combination of, the following: text or multimedia.

29. The system as per claim 26, wherein a message received via a messaging service triggers the reception of data comprising the digitized format of dictated inputs.

30. The system as per claim 29, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

31. The system as per claim 26, wherein authentication of a subscriber is performed prior to said reception of data, said authentication performed via a messaging service.

32. The system as per claim 31, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

33. The system as per claim 26, wherein said received data is preprocessed at an interactive voice response server that receives said dictated audio inputs and converts said received inputs into said digitized format.

34. The system as per claim 26, wherein said received data further comprises multimedia assets associated with said digitized audio inputs.

35. The system as per claim 34, wherein said multimedia assets comprise any of, or a combination of, the following: visual text, animation, video, motion picture, a numeric representation, or a visual representation.

36. The system as per claim 26, wherein said on-demand retrieval request is initiated based upon an automated notification sent to a telecommunication device, said automated notification triggered by an update to said stored data.

37. The system as per claim 36, wherein said notification is any of the following: a voice mail, a telephone call, or a message via a messaging service.

38. The system as per claim 37, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

39. The system as per claim 26, wherein said network is any of the following: local area network (LAN), wide area network (WAN), wireless network, telecommunication network, or the Internet.

40. A system to adapt a printed work for on-demand retrieval and modification by one or more subscribers associated with said printed work, said adaptation performed over existing telecommunication infrastructures, said printed work digitized and stored in a server capable of communicating with said subscribers, said system comprising:
a first server monitoring and identifying modifications to digitized stored data corresponding to a printed work, said modifications performed by a subscriber associated with said printed work and, upon successful modification to said digitized stored data by a subscriber, generating and forwarding an automatic notification for transmission via a messaging service for remainder of said subscribers;
a second server receiving said forwarded automatic notification and transmitting said automatic notification to said remainder of subscribers via said messaging service; and
wherein said second server receives a request for on-demand retrieval of said stored data from a telecommunication device associated with at least one of said remainder of subscribers; and transmits requested on-demand printed content in a format suitable of being rendered in said requesting telecommunications device.

41. The system as per claim 40, wherein said requesting telecommunications device is a mobile telephone, Personal Digital Assistant (PDA), or a fixed line telephone.

42. The system as per claim 40, wherein said stored digitized data is any of, or a combination of, the following: text or multimedia.

43. The system as per claim 40, wherein said messaging service is any of the following: short code messaging service (SMS), enhanced messaging service (EMS), multimedia messaging service (MMS), messaging based on Compact Media Extensions (CMX), messaging based on the Java platform, or messaging based on the Wireless Application Protocol (WAP).

44. The system as per claim 40, wherein authentication of a subscriber is performed prior to receiving data, said authentication performed via a messaging service.

45. The system as per claim 44, wherein said messaging service is any of the following: short code messaging service (SMS), enhanced messaging service (EMS), multimedia messaging service (MMS), messaging based on Compact Media Extensions (CMX), messaging based on the Java Platform, or messaging based on the Wireless Application Protocol (WAP).

46. The system as per claim 40, wherein said stored data further comprises multimedia assets associated with said printed work.

47. The system as per claim 46, wherein said multimedia assets comprise any of, or a combination of, the following: visual text, animation, video, motion picture, a numeric representation, or a visual representation.

48. The system as per claim 40, wherein said network is any of the following: local area network (LAN), wide area network (WAN), wireless network, telecommunication network, or the Internet.

49. A method to adapt a printed work for retrieval over existing telecommunication infrastructures, said method comprising the steps of:
receiving data via a network, said received data comprising a digitized format of a printed work;
storing said received data in a format appropriate for on-demand retrieval via at least one telecommunication device;
receiving a request for on-demand retrieval of said stored data from a telecommunication device; and
transmitting requested on-demand printed content in a format suitable of being rendered in said requesting telecommunications device.

50. The method as per claim 49, wherein said request for on-demand retrieval is received via a messaging service.

51. The method as per claim 50, wherein said messaging service is any of the following: short code messaging service (SMS), enhanced messaging service (EMS), multimedia messaging service (MMS), messaging based on Compact Media Extensions (CMX), messaging based on the Java Platform, or messaging based on the Wireless Application Protocol (WAP).

52. The method as per claim 49, wherein said transmitted printed content is via a messaging service.

53. The method as per claim 52, wherein said messaging service is any of the following: short code messaging service (SMS), enhanced messaging service (EMS), multimedia messaging service (MMS), messaging based on Compact Media Extensions (CMX), messaging based on the Java Platform, or messaging based on the Wireless Application Protocol (WAP).
